(19) United States
(12) Patent Application Publication
(10) Pub. No.: US 2003/0071115 A1
(43) Pub. Date: Apr. 17, 2003

(54) Data transmission method and device

(76) Inventors: Michael Horn, Deutschland (DE); Hans-Hermann Wolf, Muenchen (DE)

Correspondence Address: BELL, BOYD & LLOYD, LLC, P. O. BOX 1135, CHICAGO, IL, 60690-1135, US

(21) Appl. No.: 09/980,174

(22) PCT Filed: Mar. 30, 2001
(86) PCT No.: PCT/DE01/01221

(30) Foreign Application Priority Data
Mar. 30, 2000 (DE) 10016237.1

(51) Int. Cl. G06F 17/60

(52) U.S. Cl. 235/379

(57) ABSTRACT

A data transfer method for topping up a prepaid electronic credit associated with a service user over a data and telecommunication network, essentially in real time, where the service user is the holder of a first electronic settlement account, and a service operator is the holder of a second electronic settlement account, and, in response to a transfer signal transmitted from a terminal of the service user, the prepaid credit is increased by a predetermined electronic sum of money and, at the same time, the sum of money is transferred from the first settlement account to the second settlement account.

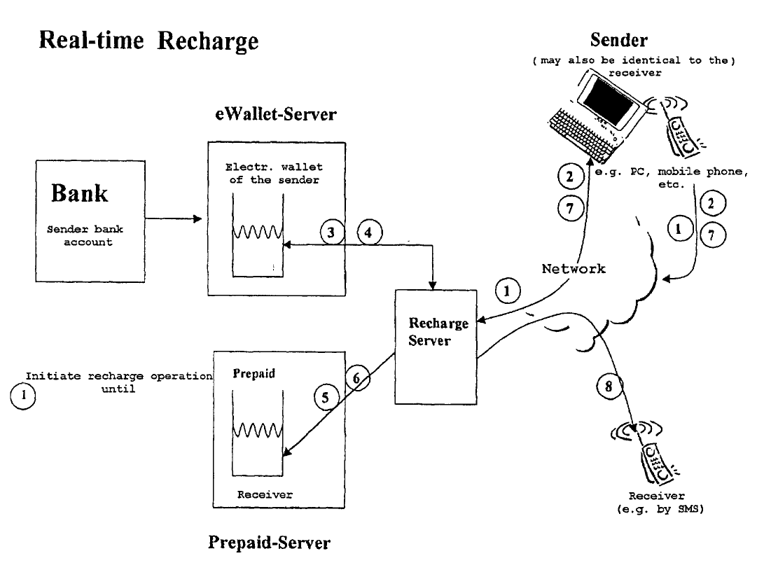

The invention relates to a data transfer method and to an appropriate arrangement for topping up a prepaid electronic credit over a data and telecommunication network.

Besides the Internet, telecommunications—in particular mobile telecommunications—today represent an area of rapid technical and economic development and a significant source of economic growth and new social developments. For a large number of the people in industrial states, the mobile telephone (“mobile”) is increasingly becoming a universal communication and information instrument and is also increasingly being used to access goods and services.

The dynamic development of mobile telecommunications has been significantly assisted in the last two to three years by the provision of tariffs on the basis of a prepaid credit (specifically in the form of “prepaid cards”). These tariffs are found to be attractive in particular on account of their comprising no basic charge irrespective of use, their providing the user with a good cost control capability and their imposing no contractual obligation. For many users wanting to use newly appearing terminals immediately, this contractual obligation is also a decisive drawback in view of the extremely dynamic development of technology and tariffs in this area. Prepaid credits appeal especially to those young and dynamic users who, on the other hand, still have relatively low incomes.

There are various methods for recharging prepaid credits which have also become established in practice. Besides purchasing a voucher, these include paying top-up sums by credit card, transfer instruction, direct debit or standing order. These payment methods are established and are familiar to the great majority of users. However, they are largely based on stable bank accounts and in turn assume a certain creditworthiness, which means that significant advantages of the prepaid method are lost again for certain user groups at this point. Some of these payment methods also involve onerous, relatively long-lasting commitment of the customer to a particular, formalized mode of payment and can be changed only with a relatively high level of complexity.

The invention is therefore based on the object of providing an improved data transfer method and an improved arrangement of the type specified above which can be used to top up a prepaid account flexibly as required in a simple and nevertheless reliable way.

The method aspect of this object is achieved by a data transfer method having the features of claim 1, and the apparatus aspect of it is achieved by a data transfer arrangement having the features of claim 10.

The invention encompasses the fundamental concept of using an “electronic wallet” (eWallet) to top up a prepaid credit, i.e. an electronic settlement account which is set up in a data network and can be electronically connected directly to the prepaid account. It also encompasses the concept of designing this settlement account—which is also referred to below as eWallet account—such that it can be “controlled” from a terminal associated with the holder of the prepaid credit (or with a third party), so that topping-up of the prepaid credit can be controlled from the terminal in real time.

The proposed method thus follows existing payment methods from the B2C (Business-to-Consumer) sector for paying for goods and services ordered over the Internet. In this context, an account management server on which the settlement account is managed—also referred to below as eWallet server—acts as a purchaser or a sender of the appropriate sum of money. Another server, on which the prepaid credit is managed—also referred to below as prepaid server—performs the function of the vendor or receiver of money. In a way, the payment option provided by the prepaid credit represents the “goods” (for example for telecommunication services).

Although a prepaid credit will normally be topped up by the holder himself, that is to say from a settlement account associated with the holder of the prepaid credit, the proposed solution is not limited to this. Instead, it also includes topping up the prepaid account from an external eWallet account. Normally, this account is then not accessed by the holder of the prepaid account, of course, but in fact by the holder of the eWallet account in order to start the transfer.

The proposed solution makes it possible to top up the prepaid account in real time, i.e. with immediate effect both for the holder and user and for the operator of the prepaid account. The electronic money is available to the operator immediately, so that the latter does not need to make any advance concession. On the other hand, the holder also need not make any advance concession without having the prepaid credit available immediately in return (as in the case of a direct debit payment, for example).

The proposed solution can be implemented as an independent service and can be offered as such to the users of the prepaid credit and runs on a specific application server The latter is also referred to below as a recharge server in view of the specific function. The recharge server also performs the connection and checking operations crucial for performing the top-up operation. A crucial function in this context is the checking of authentication and/or account data which are transferred by the user performing the top-up when the transaction is initiated. This check is made on the basis of comparison data stored in the network or in the prepaid memory.

As a fundamental connection, the recharge server sets up a connection to the prepaid server in order to ascertain the presence of the prepaid credit to be topped up and the level of this credit. In addition, a connection is set up to the (at least one) eWallet server on which the settlement accounts are managed, in order to use this connection to perform the data transfer producing the electronic transfer operation.

Finally, the recharge server maintains the telecommunication and data link set up by the terminal of the user initiating the top-up operation for the purposes of data entry under menu guidance, until a completion acknowledgement is transmitted. Optionally, the recharge server also sets up a connection to a terminal associated with the holder of the prepaid credit (if he is not identical to the user initiating the top-up). In this context, the recharge server also runs the software for controlling communication with the respective terminals, in particular under visual or audible menu guidance.

The explanations above also reveal the fundamental functional components of an arrangement suitable for implementing the invention, which means that there is no need to describe the arrangement aspects of the invention in detail again at this point. In particular, it is evident that, besides the fundamental network infrastructure—in particular a combined data and telecommunication network—it is necessary to have servers on which the prepaid credit and the settlement accounts and the application software are managed, and the user needs to have a terminal for producing the transaction and for entering the relevant data.

A preferred embodiment is described in more detail below with reference to the single figure, the individual steps being symbolized in the figure by circles containing numerals. In contrast to the use of language above, in this case the user is referred to as the “sender”. A combined telecommunication and data network is simply referred to as “NETWORK” in this case. The settlement account of the user (sender) is referred to as the “electric wallet of the sender”. The other names are in line with the explanations of terms given further above. In the example, it is assumed that the sender and the receiver are not identical, that is to say that the electronic wallet of the sender is used to top up a prepaid credit of a different receiver.

The sequence of the method is as follows:

1. The sender uses his mobile radio terminal to set up a connection to the recharge server and authenticates himself. This means that the settlement account of the sender is also clearly identifiable.

2. The recharge server uses menu guidance displayed on the sender's terminal display or else conveyed in audible form to request the sender to fill in the recharge order. Specifically, for this purpose, the sender needs to specify at least the identity (e.g. MSISDN) of the receiver's prepaid account and the sum to be transferred. If the sender has a plurality of accounts on the eWallet server, he needs to specify the identity (account number) of the eWallet required.

3. The recharge server checks with the eWallet server to determine whether the specified eWallet account of the service user exists and whether the specified amount is available in the account.

4. If this is the case, the sum is reserved (blocked).

5. The recharge server checks with the prepaid server to determine whether the specified prepaid account exists and whether the specified sum can be credited to the account.

6. If this is the case, the reserved sum is transferred from the eWallet account of the service user to a service operator account, which is likewise managed on the eWallet server, and at the same time the credit balance of the prepaid account is increased. This is done, in particular, by incrementing an appropriate counter. The money is transferred in real time.

7. The sender receives an acknowledgement about the successful transfer of money.

8. The receiver is optionally informed about receipt of the sum of money in his prepaid account.

1. A data transfer method for topping up a prepaid electronic credit associated with a service user over a data and telecommunication network, essentially in real time, where the service user is the holder of a first electronic settlement account, and a service operator is the holder of a second electronic settlement account, and, in response to a transfer signal transmitted from a terminal of the service user, the prepaid credit is increased by a predetermined electronic sum of money and, at the same time, the sum of money is transferred from the first settlement account to the second settlement account.

2. The data transfer method as claimed in claim 1, characterized in that
the prepaid electronic credit is managed on a credit management server in the data network or a telecommunication network connected thereto, and the settlement account is managed on an account management server in the data network, and a piece of money transfer software is implemented on an application server in the data network or communication network.

3. The data transfer method as claimed in claim 2, characterized in that
the terminal of the service user sets up a connection to the application server,
the terminal is used to transfer an authentication code and/or a credit identifier for the prepaid credit and an account identifier for the settlement account and also the predetermined sum of money to the application server,
the application server checks the transmitted data and the sufficiency of the predetermined sum of money in the settlement account,
if the result of the check is positive, the predetermined sum of money is debited from the first settlement account and is credited to the second settlement account and, at the same time, the prepaid credit is increased by the sum of money and
a log record is created for the debit/credit operation.

4. The data transfer method as claimed in claim 3, characterized in that
when the transaction has been performed, the application server transmits an acknowledgement signal to the terminal of the service user.

5. The data transfer method as claimed in claim 3 or 4,
characterized in that,
to check the credit identifier, a connection is automatically set up between application server and credit management server, and,
to check the account identifier of the settlement account, a connection is automatically set up between application server and account management server.

6. The data transfer method as claimed in one of claims 3 to 5,
characterized in that
the authentication code or credit and account identifier and the predetermined sum of money are entered on the terminal of the service user by keyboard or voice entry under menu control.

7. The data transfer method as claimed in one of the preceding claims,
characterized in that
a first service user is the holder of the prepaid electronic credit, and a second service user is the holder of the first electronic settlement account, and the credit of the first service user is increased by the electronic sum of money in response to a transfer signal from a terminal associated with the second service user.

8. The data transfer method as claimed in claim 7, characterized in that
the application server transmits a first and a second acknowledgement signal to the first and the second service user, respectively, when a transfer has been made.

9. The data transfer method as claimed in one of the preceding claims,
characterized in that
at least part of the transfer operation is performed over a mobile radio network.

10. A data transfer arrangement for topping up a prepaid electronic credit of a service user over a data and telecommunication network, essentially in real time,
characterized by
a credit counter, managed on a credit management server, for storing the electronic credit,
a first and second settlement account memory on at least one account management server,
a piece of money transfer software, implemented on an application server, for electronically transferring money from the settlement account memory to the credit memory,
a service user terminal connected to the data and telecommunication network for the purpose of entering and transmitting data required for topping up the credit to the application server, and
a data link between the application server, the credit management server, the account management server and the terminal for the purpose of performing the data transfers which top up the credit.

11. The data transfer arrangement as claimed in claim 10,
characterized in that
the terminal is a mobile radio terminal connected to a mobile radio network and/or the prepaid credit is stored on a prepaid card associated with a service operator in a mobile radio network.

12. The data transfer arrangement as claimed in claim 10 or 11,
characterized in that
a trigger signal is transmitted from a first terminal in order to trigger the transfer of money from the settlement account memory to the second settlement account memory and to increase the count of the credit counter, and the prepaid electronic credit is associated with a second terminal.

13. The data transfer arrangement as claimed in claim 11 and 12,
characterized in that
the prepaid card is associated with the second terminal as a mobile radio terminal.

14. The data transfer arrangement as claimed in one of claims 10 to 13,
characterized in that
the application server has an authentication code memory and a comparison unit, connected thereto at the input, for comparing an authentication code received from the first terminal with a stored authentication code and for outputting an enable signal for the payment operation if the two match.

15. The data transfer arrangement as claimed in claim 14,
characterized in that
the application server has a decoding unit for obtaining a credit and/or account identifier for the prepaid electronic credit or for the settlement account from the authentication code.
